(19) United States
(12) Patent Application Publication
(10) Pub. No.: US 2012/0246211 A1
(43) Pub. Date: Sep. 27, 2012

(54) SYNTACTICAL SYSTEM AND METHOD FOR CHROMATOGRAPHIC PEAK IDENTIFICATION

(76) Inventor: Fred E. Lytle, Indianapolis, IN (US)

(21) Appl. No.: 13/428,062

(22) Filed: Mar. 23, 2012

Related U.S. Application Data
(60) Provisional application No. 61/467,216, filed on Mar. 24, 2011.

(51) Int. Cl. G06F 7/38; G06F 17/10

(52) U.S. Cl. 708/315; 708/443

(57) ABSTRACT

A system and method identifies data peaks representative of empirical data of a sample. The system and method assign a grammar type to correspond to data points represented on a data plot such as a chromatogram and identify the presence of a peak syntax based on an analysis of the grammar element types assigned to the data points of the chromatogram.

### BACKGROUND

The present disclosure relates to chromatographic peak detection and identification. More specifically, the field of the present disclosure is that of a system and method for syntactical identification and location of chromatographic peaks.

Empirical data associated with a sample and produced by analytical instrumentation may be analyzed and processed for many reasons. In general, the analysis of such empirical data is performed by computer software programs, which may present the empirical data in the form of a chromatogram (a graphic representation of the empirical data). One feature of chromatograms which is often desired relates to identification of a general or local peak of the data (e.g., a place on the chromatogram where a local or global high point exists). Information about features of a data peak, such as x and y-axis coordinates of a data peak or the area underneath a data peak, for example, may be used in deriving specific and valuable information about the analyzed sample (such as concentration, purity, and identity).

Chromatography and mass spectrometric detection are common techniques used for chemical compound identification, quantification, and other forms of analysis that represent empirical data in the form of a chromatogram. For example, the presence and location of a peak on a chromatogram, associated with analysis of a chemical compound, may represent time-based concentration measurements of the compound. Such information is valuable for a variety of research and regulatory applications.

Two common mathematical approaches for identifying peaks include the use of matched filters and derivatives. (See, for example: Attila Felinger, “Data analysis and signal processing in chromatography,” Volume 21 in Data Handling in Science and Technology, Elsevier, Amsterdam, 1998, Chapter 8). In general, matched filters are based on noise reduction by multiplication in the frequency domain for providing an optimum signal-to-noise ratio. The derivatives approach, in general, involves the computation of one or more derivatives relating to empirical data points to differentiate the data points from other points within a chromatogram. Mathematical approaches for identifying peaks may also be used in conjunction with smoothing techniques for processing data points (e.g., background noise is minimized or peak shapes are assumed).

While sophisticated and statistically valid methods of peak detection exist, there are various problems with current methods of peak detection, particularly with difficult data such as “noisy” data or data in which the peak shape changes significantly.

### SUMMARY

The present disclosure provides a system and method for syntactical identification and location of chromatographic peaks.

According to one embodiment, a method determines the presence of at least one data peak within a plurality of data points representing at least two empirical data variables relating to a sample. The method includes determining at least one of a first and a second derivative for each of a plurality of the data points, assigning one of a plurality of grammar elements to correspond to a plurality of the data points, the assigning including a comparing of at least one of the first and second derivative to a reference value, and compiling a grammar listing in which a grouping of grammar elements representative of a peak syntax may be identified therein for indicating the presence of at least one data peak. The steps of determining, assigning, and compiling are performed by executing a computer readable program using a processor of a computing device. Further, according to another embodiment, the disclosed method displays a chromatogram including a plurality of the data points, to the user.

According to another embodiment of the disclosed method, the plurality of grammar elements includes at least one of a baseline grammar element, a rising edge grammar element, an apex grammar element, and a falling edge grammar element. Additionally, the grammar element assigned to each data point may be indicative of a ratio of a particular slope value of the data point to a value related to a zero baseline. Further, the slope value may be derived from at least one of a first and a second derivative value of the data point and may include a smoothing process for the data point. According to one embodiment of the instant methods, the smoothing process includes convolving the data with a smoothing filter,

$${smooth}_{i} = {\sum }_{j = - M}^{M} f 0 ( j ) {data}_{i + j}$$

$$where$$

$$f 0 ( j ) = \frac{sin ( π {f}_{e} j )}{π {f}_{e} j} exp ( - π {f}_{r}^{2} {j}^{2} ) ,$$

i is the index of the data value being smoothed, the length of the filter is given by 2M+1 where M is a positive whole number, and f0(0)=1.

According to an embodiment of the disclosed method, the first derivative value is also obtained by convolution with a filter,

$$deriv {1}_{i} = {\sum }_{j = - M}^{M} f 1 ( j ) {data}_{i + j}$$

$$where$$

$$f 1 ( j ) = - \frac{1}{π {f}_{e} {j}^{2}} exp ( - π {f}_{r}^{2} {j}^{2} ) [ π {f}_{e} j cos ( π {f}_{e} j ) - sin ( π {f}_{e} j ) - 2 π {f}_{r}^{2} {j}^{2} sin ( π {f}_{e} j ) ]$$

and f1(0)=0. Additionally, according to an embodiment of the present disclosure, the second derivative is obtained by convolution with a filter,

$$deriv {2}_{i} = {\sum }_{j = - M}^{M} f 2 ( j ) {data}_{i + j}$$

$$where$$

$$f 2 ( j ) = exp ( - π {f}_{r}^{2} {j}^{2} ) [ a \frac{sin ( π {f}_{e} j )}{π {f}_{e} j} + b cos ( π {f}_{e} j ) ]$$

$$a = {π}^{2} {f}_{r}^{4} {j}^{2} + 2 π {f}_{r}^{2} + 2 / {j}^{2} - {π}^{2} {f}_{e}^{2}$$

$$b = - 2 / {j}^{2} - 4 π {f}_{r}^{2}$$

$$and f 2 ( 0 ) = - {π}^{2} {f}_{e}^{2} / 3 - 2 π {f}_{r}^{2}$$

In all above equations j runs over the interval from −M . . . 0 . . . M in unit steps.

According to another embodiment, the plurality of peak syntax includes a normal syntax, a rising shoulder syntax, and a falling shoulder syntax. According to this embodiment, the normal syntax is indicative of the presence of the grammar element arrangement: rising edge, apex, falling edge; and the rising shoulder syntax is indicative of the presence of the grammar element arrangement: rising edge, apex, rising edge, apex, falling edge; and the falling shoulder syntax is indicative of the presence of the grammar element arrangement: rising edge, apex, falling edge, apex, falling edge.

In yet another embodiment, the method further includes the step of assigning a probability of assignment value to each of the grammar types assigned to each of the data points. Additionally, the step of identifying may further include analyzing the probability of assignment value associated with each grammar element.

In yet another embodiment, the step of indicating includes providing a peak list including a peak start location, a peak end location, and a peak apex location for at least one data peak shown in the indicating step. Additionally, according to an embodiment, the step of indicating may include indicating the presence of a peak syntax by presenting a data peak on a chromatogram. Further, the instant method may include a step of assigning one of a plurality of grammar segments to a plurality of data points that include at least one empirical data variable, that are in close proximity to each other, and that have a concentration of like grammar types, wherein the grammar listing includes a plurality of the assigned grammar segments.

In another embodiment of the instant disclosure, the plurality of data points may include replicate data points of the sample. The replicate data points of the sample may be derived from the computer readable program which receives the empirical data of the sample and derives replicate data points therefrom.

According to another embodiment of the instant disclosure, a system for identifying a data peak is disclosed. The system includes a computing device having a processor, an associated memory, and a peak identification software module stored in the memory and having a plurality of machine readable instructions enabling the processor to receive empirical data including a plurality of data points relating to a sample, each data point representative of at least two empirical data variables relating to the sample, the software module further enabling the processor to assign one of a plurality of grammar elements to each of the plurality of data points, compile a grammar listing, identify a grouping of grammar elements representative of a peak syntax within the grammar listing, and indicate the presence of a peak syntax. According to another embodiment of the disclosed system, the plurality of grammar elements comprises a baseline grammar element, a rising edge grammar element, an apex grammar element, and a falling edge grammar element.

In a further embodiment of the disclosed system, the grammar element is derived from at least one of a first and a second derivative value of the data point, the first and second derivative values of the data point being indicative of a ratio of a slope of the data point to a value representing a zero baseline. It is also a further embodiment of the disclosed system that the grammar element assigned to each data point is further derived from a smoothing process of the data point.

According to another embodiment of the disclosed system, the software module indicates the presence of a peak syntax by presenting a data peak on a chromatogram.

According to yet another embodiment of the disclosed system, the computing device is integral with the analytical instrumentation adapted to generate the plurality of data points.

### BRIEF DESCRIPTION OF THE DRAWING FIGURES

The above-mentioned aspects of exemplary embodiments will become more apparent and the disclosure itself will be better understood by reference to the following description of embodiments of the disclosure taken in conjunction with the accompanying drawing, wherein:

FIG. 1 is a schematic diagrammatic view of a network system in which embodiments of the present disclosure may be utilized;

FIG. 2 is a block diagram of a computing system (either a server or client, or both, as appropriate) with optional input devices (e.g., keyboard, mouse, touch screen, etc.) output devices, hardware, network connections, one or more processors, and memory/storage for data and modules, etc., which may be utilized in conjunction with embodiments of the present disclosure;

FIG. 3 is an illustration of a chromatogram comprising raw data points;

FIG. 4A is a schematic of a syntactical system for chromatographic peak identification;

FIG. 4B is a schematic of another embodiment of a syntactical system for chromatographic peak identification;

FIG. 5 is an illustration of a chromatogram comprising both raw data points and a smooth trace;

FIG. 6 is a flow chart of a method of syntactical chromatographic peak identification;

FIG. 7 is an illustration of a chromatogram illustrating one of a plurality of grammar elements assigned to data points of the chromatogram; and

FIG. 8 is an embodiment of a peak list according to an exemplary embodiment.

Corresponding reference characters indicate corresponding parts throughout the several views. Although the drawing figures represent embodiments of the present disclosure, the drawing figures are not necessarily to scale and certain features may be exaggerated in order to better illustrate and explain the present disclosure. The flow charts are also representative in nature, and actual embodiments of the disclosure may include further features or steps not shown in the drawing figures.

### DETAILED DESCRIPTION

The embodiments disclosed herein are not intended to be exhaustive or limit the disclosure to the precise form disclosed in the following detailed description. Rather, the embodiments are chosen and described so that others skilled in the art may utilize their teachings.

The detailed descriptions which follow are presented in part in terms of algorithms and symbolic representations of operations on data bits within a computer memory that represent alphanumeric characters or other information. These descriptions and representations are used by those skilled in the art of data processing to effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to such quantities.

Some algorithms may use data structures for both inputting information and producing the desired result. Data structures greatly facilitate data management by data processing systems, and may not be directly accessible. Data structures are not the information content of a memory. Rather, they represent specific structural elements which impart a physical organization on the information stored in memory. More than mere abstraction, the data structures are typically specific electrical or magnetic structural elements in memory which simultaneously represent complex data accurately and provide increased efficiency in computer operation.

Manipulations performed in the data processing are often referred to in terms, such as comparing or adding, commonly associated with mental operations performed by a human operator. No such capability of a human operator is necessary, or desirable in most cases, in any of the operations described herein which form part of the present disclosure; the operations are machine operations. Useful machines for performing the disclosed operations include general purpose digital computers or other similar devices. In all cases the distinction between the method operations of a computer and the method of computation itself should be recognized. The present disclosure relates to a method and apparatus for operating a computer in processing electrical or other (e.g., mechanical, chemical) physical signals to generate other desired physical signals.

The present disclosure also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps.

The present disclosure may be practiced with “object-oriented” software, and particularly with an “object-oriented” operating system. The “object-oriented” software is organized into “objects,” each typically including a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects. Objects are reusable software components that model physical items.

Messages are sent and received between objects having certain functions and having knowledge to carry out processes. Messages are generated in response to user instructions, for example, by a user activating an icon with a “mouse” pointer and thereby generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of an object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by messages effects an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences and combinations of message and response may continue or may come to an end when all messages have been responded to and no new messages are being sent. When modeling systems utilize an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works by simply observing the readily apparent manifestations of its operation. Most of the operations carried out by a computer in response to a program are “invisible” to an observer because typically only a relatively few steps in a program produce an observable computer output.

Several terms which are used frequently have specialized meanings in the present context. The term “object” relates to a set of computer instructions and associated data which can be activated directly or indirectly by the user. The terms “windowing environment,” “running in windows,” and “object-oriented operating system” are used to denote a computer user interface in which information is manipulated and displayed on a video display such as within bounded regions on a raster scanned video display. The terms “network,” “local area network,” “LAN,” “wide area network,” and “WAN” refer to two or more computers which are connected so that messages may be transmitted between the computers. In such computer networks, typically one or more computers operate as a “server,” a computer with large storage devices such as hard disk drives and communication hardware to operate peripheral devices such as printers or modems. Other computers, termed “workstations,” provide a user interface so that users of computer networks can access network resources, such as shared data files, common peripheral devices, and inter-workstation communication. Users activate computer programs or network resources to create “processes” which include both the general operation of the computer program along with operations having specific characteristics determined by input variables and environment.

The terms “desktop,” “personal desktop facility,” and “PDF” refer to a user interface which presents a menu or display of objects and which provides settings for the user associated with the desktop, personal desktop facility, or PDF. When the PDF accesses a network resource, which typically requires an application program to execute on the remote server, the PDF calls an Application Program Interface, or “API,” to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a worldwide network of computers, namely the “World Wide Web” or simply the “Web.” Examples of Browsers compatible with the present disclosure include the Internet Explorer program (Internet Explorer is a trademark of Microsoft Corporation), the Opera Browser program created by Opera Software ASA, the Firefox browser program (Firefox is a registered trademark of the Mozilla Foundation), and others. Although the following description details such operations in terms of a graphic user interface of a Browser, the present disclosure may be practiced with text based interfaces, with voice or visually activated interfaces, having many of the functions of a graphic based Browser, and others.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text and images, and to play audio and video recordings. The Web utilizes these data file formats in conjunction with a communication protocol to transmit such information between servers and workstations. Browsers may also be programmed to display information provided in an eXtensible Markup Language (“XML”) file, with XML files being capable of use with several Document Type Definitions (“DTD”), thus being more general in nature than SGML or HTML. The XML file may be analogized to an object because the data and the stylesheet formatting are separately contained (formatting may be thought of as methods of displaying information; thus, an XML file has data and an associated display method).

The term “personal digital assistant” or “PDA” refers to any handheld, mobile device that combines computing, telephone, fax, e-mail and networking features. The terms “wireless wide area network” and “WWAN” refer to a wireless network that serves as the medium for the transmission of data between a handheld device and a computer. The term “synchronization” refers to the exchanging of information between a handheld device and a desktop computer either via wires or wirelessly. Synchronization ensures that the data on both the handheld device and the desktop computer are identical.

In wireless wide area networks, communication primarily occurs by transmission of radio signals over analog, digital cellular, or personal communications service (“PCS”) networks. Signals may also be transmitted through microwaves and other electromagnetic waves. Wireless data communication may take place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”).

The terms “wireless application protocol” and “WAP” refer to a universal specification that facilitates the delivery and presentation of web-based data on handheld and mobile devices with small user interfaces.

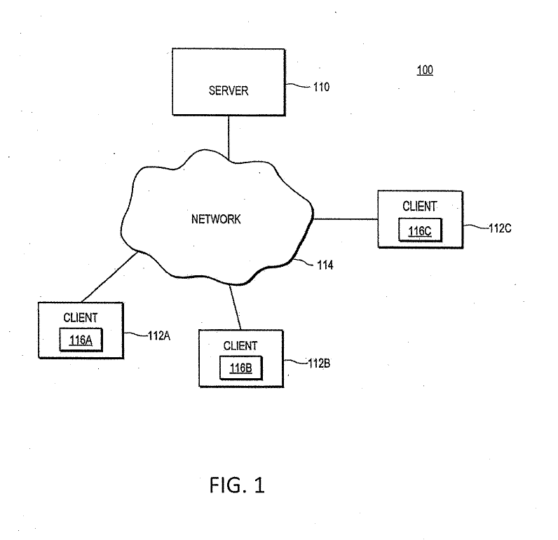

FIG. 1 is a high-level block diagram of a computing environment 100 according to an exemplary embodiment. A server 110 and three clients 112 (a client may be any sort of computing device, a personal computer, smart phone, tablet, etc.) are connected by network 114. Only three clients 112 (A, B, and C) are shown in order to simplify and clarify the description. Embodiments of the computing environment 100 may have thousands or millions of clients 112 connected to network 114, for example the Internet. Users may operate software 116 on one of clients 112 to both send and receive messages through network 114 via server 110 and its associated communications equipment and software.

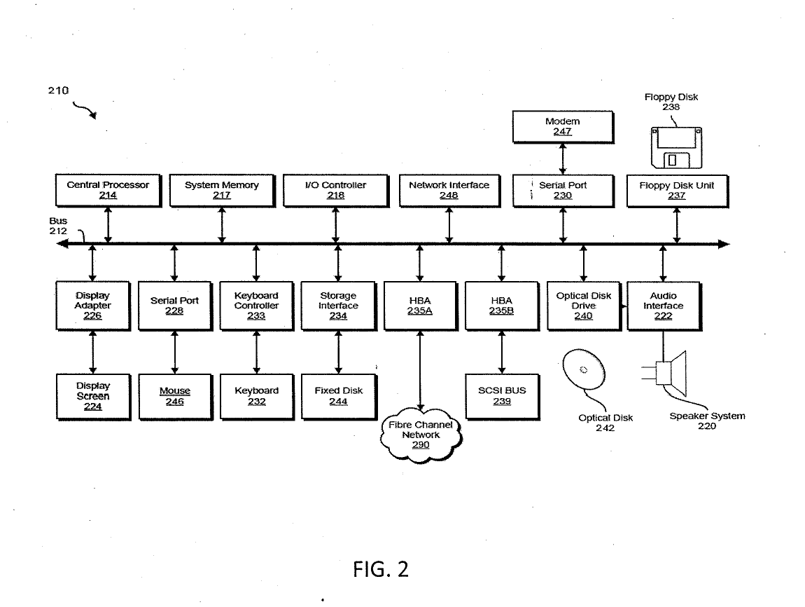

FIG. 2 is a block diagram of a computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, an external audio device, such as speaker system 220 operating via audio output interface 222, an external device, such as display screen 224 operating via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and an optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown). RAM may be utilized as memory into which operating system and application programs are loaded. ROM or flash memory may contain, among other software code, Basic Input-Output system (BIOS) for controlling basic hardware operation such as interaction with peripheral components. Applications resident with computer system 210 may be stored on and accessed via computer readable media, such as hard disk drives (e.g., fixed disk 244), optical drives (e.g., optical drive 240), floppy disk unit 237, or other storage medium. Additionally, applications may utilize electronic signals modulated in accordance with a particular application and data communication technology when accessed via network modem 247 or interface 248 or via other telecommunications equipment (not shown).

Storage interface 234, as with other storage interfaces of computer system 210, may connect to standard computer readable media, such as fixed disk drive 244 for storage and/or retrieval of information. Fixed disk drive 244 may be part of computer system 210 or may be separate and accessed through other interface systems. Modem 247 may provide direct connection to remote servers via a telephone link or to other computers on the Internet via an internet service provider (ISP) (not shown). Network interface 248 may provide direct connection to remote servers via direct network link to the Internet, for example by a POP (point of presence). Network interface 248 may provide such connection using wireless techniques, such as by digital cellular telephone connection, Cellular Digital Packet Data (CDPD) connection, digital satellite data connection, or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown. Operation of a computer system such as that shown in FIG. 2 is readily known in the art and is not discussed in detail in this application. Software source and/or object codes, or compilations thereof, for implementing the present disclosure may be stored in computer-readable storage media such as one or more of system memory 217, fixed disk 244, optical disk 242, and floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system.

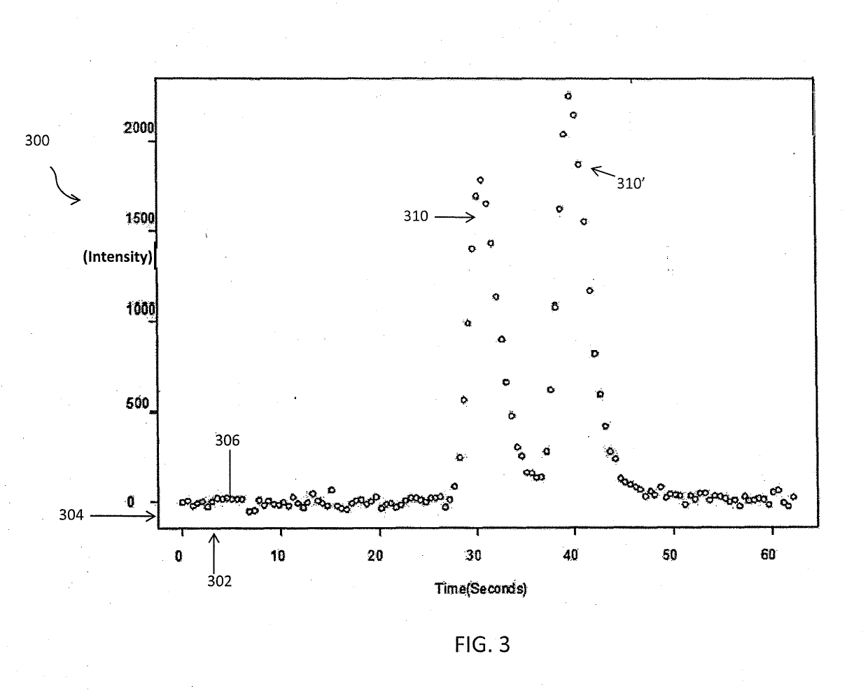

FIG. 3 is a graphic representation of a plurality of data points 306 illustrated in the form of a chromatogram 300. Although the graphic representation of a plurality of data points 306 is in the form of a chromatogram 300, the disclosed syntactical system does not require any form of graphical representation. However, a series of observed or measured data of a plurality of data points may be presented in graphical form as data points plotted as a function of two or more factors (or variables). For purposes of simplicity and consistency herein, a graphic representation of data points as a function of two or more factors (or variables) is referred to generically as a chromatogram.

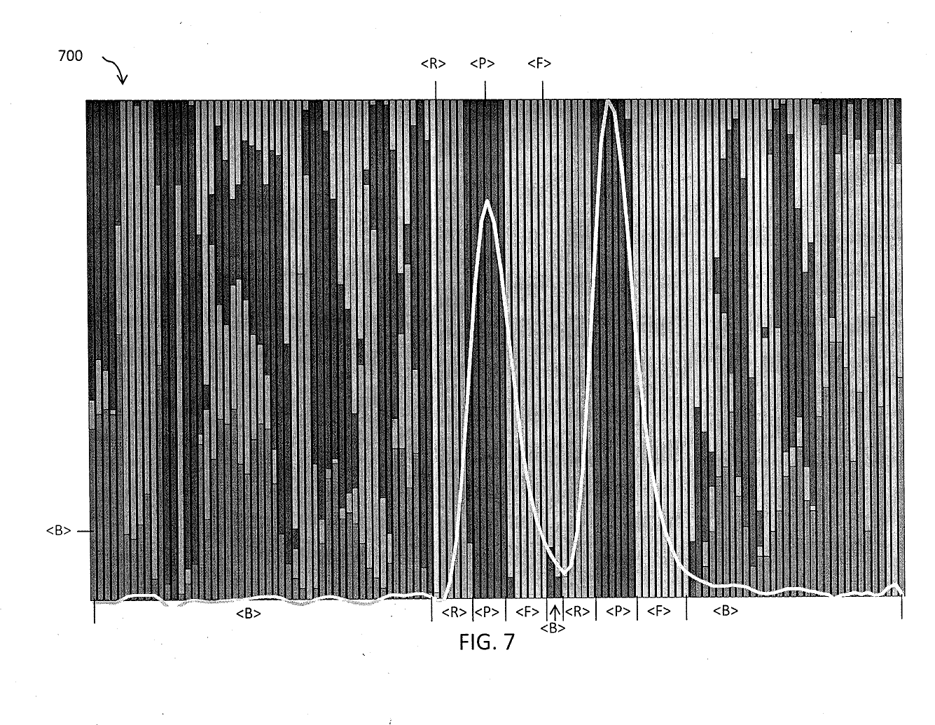

The illustrated plurality of data points 306 represents raw analytical data collected during the analysis of a sample. Each of the plurality of data points 306 of chromatogram 300 is assigned a grammar element (see, e.g., <B>, <R>, <P>, and <F> of FIG. 7), whereby the disclosed syntactical system accurately identifies peak syntaxes within a listing of the assigned grammar elements.

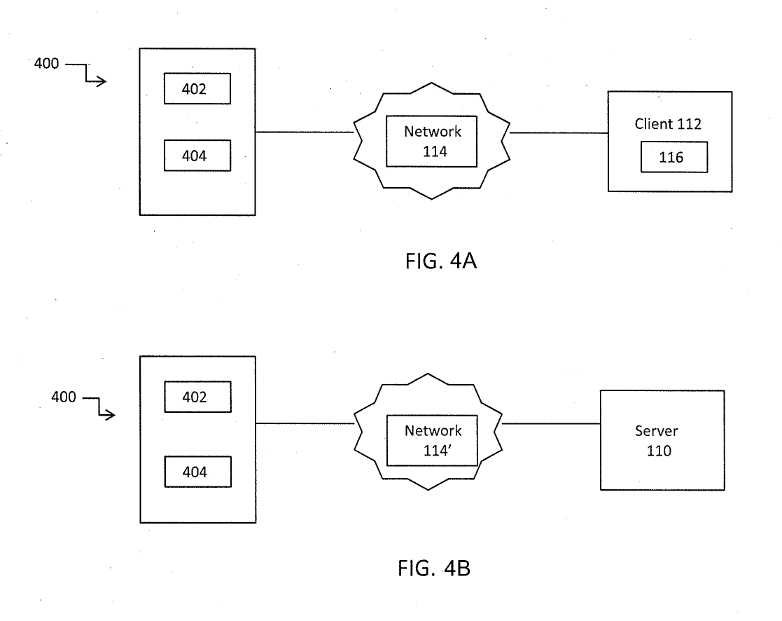

FIG. 4A and FIG. 4B schematically show systems where the data represented by chromatogram 300 may be generated from any of a variety of analytical instrumentation 400 capable of analyzing various types of samples. One embodiment of the disclosed syntactical system includes analytical instrumentation 400, sample analysis component 402, and data collection component 404.

Sample analysis component 402 of analytical instrumentation 400 produces raw data which is collected by data collection component 404 during the analysis of a sample. The collected raw data is communicated to client 112 or server 110, for example, through network 114 (FIG. 4A) such as a local network or network 114′ (FIG. 4B), for example the Internet, whereby the data is processed and displayed as a plurality of data points 306 in chromatogram 300.

Analytical instrumentation 400 may include as an integral component client 112 with software 116.

Analytical instrumentation 400 may include a variety of instrumentation capable of analyzing various types of samples. By way of non-limiting example, sample analysis component 402 of analytical instrumentation 400 may include chromatography instrumentation, such as liquid chromatography instrumentation. Data collection component 404 may include mass spectrometric detection instrumentation used (in conjunction with chromatography instrumentation) in techniques such as chemical compound analysis. Additionally, analytical instrumentation 400 may include polymerase chain reaction detection instrumentation (e.g., micro-well plate readers, gel readers, and real-time PCR instrumentation) used in techniques such as nucleic acid analysis. Further, analytical instrumentation 400 may include enzyme-linked immunosorbent assay instrumentation and associated detection instrumentation used in techniques such as protein analysis. Thus, the disclosed syntactical system and method may be used in the analysis of chromatograms representing data from a variety of sample types including, but not limited to, chemical compounds, nucleic acids, proteins, tissues, emulsions and plasmas, gases, and liquids. As such, analytical instrumentation 400 may include instrumentation suitable for the analysis and collection of raw data generated for a variety of samples.

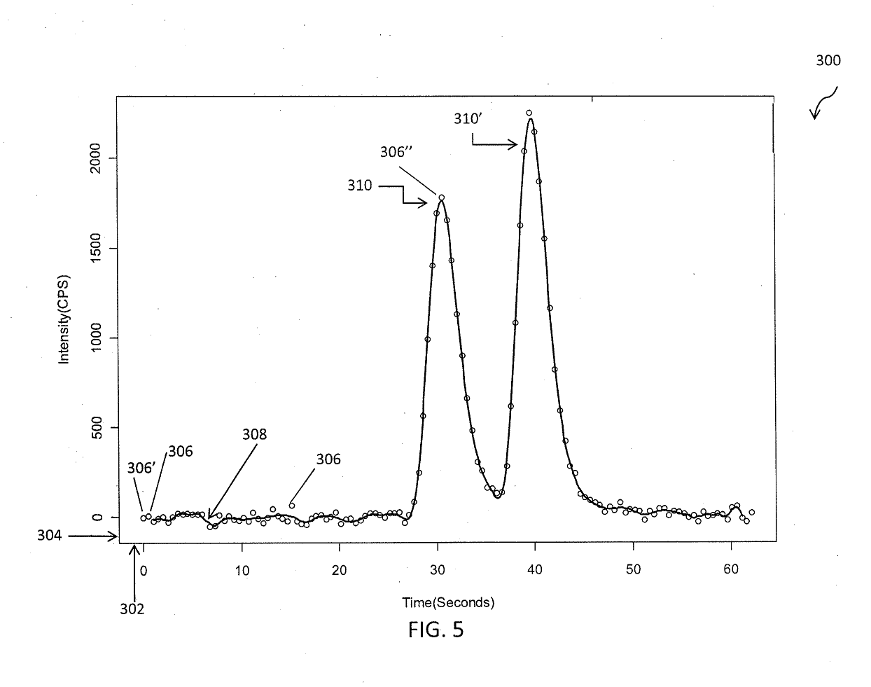

FIG. 5 shows a chromatogram 300 having an x-axis 302, y-axis 304, plurality of data points 306, smoothed trace 308, and first peak 310 and second peak 310′. While chromatogram 300 depicts two peaks (first peak 310 and second peak 310′) the possible embodiments of chromatogram 300 may comprise no peaks, one peak, or more than two peaks according to the underlying data. Such chromatograms and similar non-graphically plotted data are also within the scope of the present disclosure.

X-axis 302 is depicted in FIG. 5 as indicating “time” (in seconds), and x-axis 302 may provide data indicative of any of a variety of factors (or variables) relating to the analyzed sample such as: concentration, cell number (or density), mass, area (or surface area), pressure, and the like. FIG. 5 also depicts y-axis 304 as indicating “intensity” in counts per second (CPS), and y-axis 304 may indicate any of a variety of factors (or variables) relating to the analyzed sample including, but not limited to, duration, pressure, voltage, distance, florescence, and the like.

The plurality of data points 306 represents the raw data (e.g., produced and collected by analytical instrumentation 400 during analysis of a sample) associated with one or more characteristics of the analyzed sample. Specifically, each of the plurality of data points 306 in FIG. 5 indicates the intensity (generated during the analysis of the sample) at a given point in time (seconds) during the analysis. For example, data point 306′ indicates the analysis of a sample that caused zero intensity (CPS) units to be produced at zero seconds Likewise, data point 306″ indicates the analysis of the sample that caused approximately 1750 intensity (CPS) units to be generated at 30 seconds.

Smooth trace 308 represents a “smoothing” of the raw data represented by plurality of data points 306. As will be described in further detail below, according to embodiments of the disclosed syntactical system, the raw data (represented by plurality of data points 306) may be “smoothed,” (e.g., corrected for noise induced variances and other distortions) by various methods or algorithms. In general, “noise” includes any variance which may alter or disrupt the representations of empirical data on a chromatogram. Ideally, smoothing reduces or eliminates noise variances without distorting the values of the raw data represented on a chromatogram.

First peak 310 and second peak 310′ (collectively referred to as “data peaks”) are also depicted. Data peaks represent high points, or localized areas within chromatogram 300, indicating characteristics of the analyzed sample. The identification and location, as well as other characteristics, associated with data peaks are often important in the analysis of the samples. For mathematical simplicity herein, data peaks are modeled as possessing a Gaussian shape according to Gauss's equation:

$$G ( t ) = A exp ( - {π ( \frac{t}{{t}_{0}} )}^{2} ) .$$

Although described herein according to Gauss's equation, it should be understood that the disclosed syntactical method may also be utilized with data peaks described by other equations including, but not limited to, the Frazer-Suzuki Model:

$$f ( t ) = h exp [ - \frac{1}{2 {a}^{2}} {ln}^{2} ( 1 + \frac{a ( t - m )}{σ} ) ]$$

(where h is the peak height, m is the peak mean, a is related to the peak width, and a is an adjustable parameter that determines the extent of skewedness, when a=0 the peak has no skew, when a>0 the peak is skewed to longer times (shows tailing), when a<0 the peak is skewed to shorter times (shows peak fronting));

### The Weibull Function Model:

$$f ( t ) = {h ( \frac{t - {t}_{0}}{{t}_{m} - {t}_{0}} )}^{b - 1} exp \{ \frac{b - 1}{b} [ 1 - {( \frac{t - {t}_{0}}{{t}_{m} - {t}_{0}} )}^{b} ] \}$$

(where the parameters are the same as the last peak shape, except b>0);

### The Exponentially Modified Gaussian (EMG) Model:

$$f ( t ) = \frac{A}{2 τ} exp ( \frac{{σ}^{2}}{2 {τ}^{2}} - \frac{t - {t}_{R}}{τ} ) [ 1 - erf ( \frac{σ}{τ \sqrt{2}} - \frac{t - {t}_{R}}{σ \sqrt{2}} ) ]$$

(where A is the peak height, t_{R} is the peak maximum, σ is related to the peak width, τ is related to peak skewedness, and erf( ) is the error function); and

### The Bi-Gaussian Model:

$$f ( t ) = \{ \begin{matrix}h exp ( - {( t - m )}^{2} / 2 {σ}_{1}^{2} ) & if t \leq m \\ h exp ( - {( t - m )}^{2} / 2 {σ}_{2}^{2} ) & if t < m\end{matrix}$$

(for example when describing peaks having different rise and fall widths, where h is the peak height, m is the peak maximum, and σ₁ and σ₂ are proportional to peak width). Other models for describing peaks, which are not shown herein but are within the scope of the disclosed system and method and which are known to those of ordinary skill in the art, include the Generalized Exponential Model, the Lognormal Function Model, and the Chesler-Cram Model. As is described in detail herein, the instant disclosure provides a method and system for accurately determining the presence and location of one or more data peaks within a chromatogram.

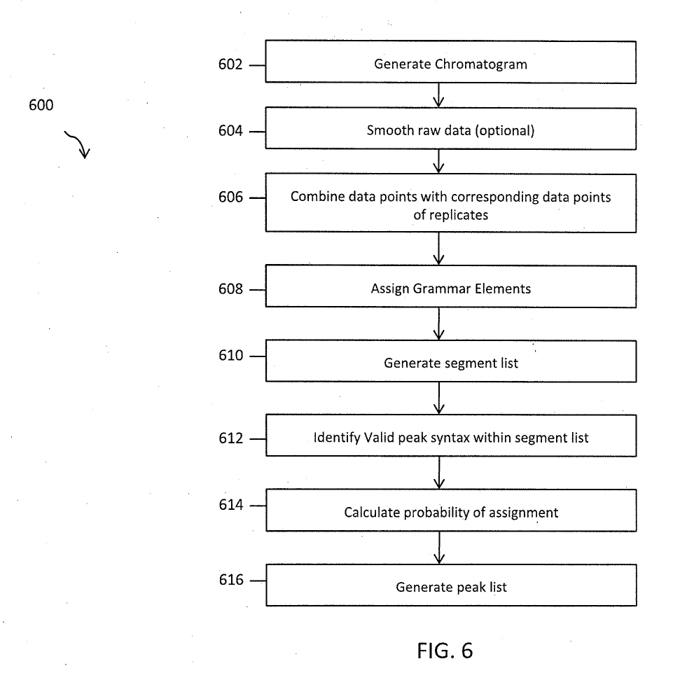

FIG. 6 is a flowchart for an exemplary embodiment of a syntactical method 600. According to step 602, a chromatogram, comprising a plurality of data points, is generated. At step 604, the raw data (represented by the plurality of data points) may optionally be “smoothed” to correct for noise variance. The term smoothed data relates to raw data that has been processed or refined by a predetermined algorithm to eliminate or minimize noise in the sample data. Smoothing of the raw data, in accordance with the present disclosure, may be accomplished in a number of ways known to those skilled in the art. By way of example, and not intended to limit the scope of the disclosed method, convolution, smoothing, matched filters, and derivative filtering are disclosed in U.S. Pat. No. 8,017,908, granted to Gorenstein, incorporated herein by reference in its entirety.

Bootstrapping as used in the present disclosure generally involves augmenting a statistically small sample with data values derived from a random sample (with replacement) from the original data set. For example, the statistical technique of bootstrapping may be used to create pseudo replicate chromatograms. These replicates have the chromatographic noise randomly redistributed in such a way that its effect on the resulting calculated data points may be averaged. In one embodiment, a bootstrap is effected by first processing the chromatogram using an optimum smoothing filter. Then the smooth trace is subtracted from the raw chromatogram to create a vector of differences or deviations which, in the absence of distortion, is the noise. At this point a predetermined number of new items, e.g. 100 new noise vectors, are created by randomly selecting values, with replacement, from the difference or deviation vector. In turn, in this exemplary embodiment, the 100 noise vectors are added to the smoothed chromatogram to generate 100 pseudo replicate chromatograms. A system and method for bootstrapping replication is disclosed in U.S. application Ser. No. 13/336,173, filed Dec. 23, 2011, entitled “Chromatographic Peak Identification using Bootstrap Replication Object Oriented System and Method,” incorporated herein by reference in its entirety.

While the syntactical method depicted in flow chart 600 applies smoothing, the use of non-smoothed data (raw data) may also be used in this syntactical method and is thus within the scope of the present disclosure. For example, when a statistically significant number of replicate samples are analyzed, non-smoothed raw data may be preferred. Additionally, when “noise” is statistically insignificant, it may be preferred to use non-smoothed data.

Referring next to step 606 of FIG. 6, each data point 306 may be a representation of a plurality of data points 306 from pseudo replicates obtained by bootstrapping as described above. Combining corresponding data points 306 from replicates provides increased statistical confidence that each data point 306 (wherein each data point 306 represents the combination of all the corresponding data points) represented on chromatogram 300 accurately represents the characteristics of the analyzed sample. Although the syntactical method depicted in flow chart 600 typically includes combining replicates, it is also within the scope of step 606 that corresponding data points for combination may be synthetically generated. Step 606 may include analysis of a sample (by analytical instrumentation 400) in duplicate, triplicate or even by use of a larger number of replicates. Each replicate of the analyzed sample may generate a plurality of additional raw data points. Raw data points from each replicate, corresponding to the same location on x-axis 302 may be combined for analysis as a single data point 306. Thus, data point 306″ of FIG. 5 may be combined with data points from replicates of the same sample collected at 30 seconds. Each of the plurality of data points 306 may optionally be “smoothed” prior to combining corresponding data points, or the corresponding data points may be combined and then smoothed as a single data point.

By way of further example, step 606 may include analysis of a sample (by analytical instrumentation 400) without replicates. Each raw data point from the sample may then be smoothed by any manner within the scope of step 604. Replicate data for each smoothed data point may then be synthetically generated by application of a mathematical theorem such that each data point 306 of the chromatogram represents a plurality of (computer generated) data points corresponding to the same x-axis location. Such may provide increased statistical confidence that each data point 306 represented on chromatogram 300 accurately represents the characteristic of the analyzed sample without requiring analysis of a statistically significant number of replicate samples.

An alternative method of synthetically generating replicate data for each data point 306 within the scope of step 606 of the present disclosure includes analyzing the variability present within each data point 306. For example, when a sample has been analyzed in replicate, but not with a statistically significant number of replicates, the variance (or error) within each replicate of each data point 306 can be calculated and accounted for (e.g., averaged and subtracted) in synthetically generating a statistically significant number of replicates by application of a mathematical theorem. Such exemplary embodiment provides a system which provides increased confidence that each data point 306 represented on chromatogram 300 accurately represents the characteristics of the analyzed sample, while utilizing only a statistically insignificant or otherwise small number of replicates.

According to one embodiment of the disclosure, step 608 is carried out by computing a first derivative and a second derivative of the raw data of each of the plurality of data points 306 and comparing the derivatives of each data point to a value corresponding to a baseline that is normalized to zero. Another embodiment provides replication software that determines at least one data point in a graph created according to predetermined criteria for a set of chromatographic data, calculates a set of deviations from the at least one data point in each set of chromatographic data, and then calculates a set of replicated data points by combining a selected data point of chromatographic data and a randomly selected deviation. Finally, analysis software performs statistical analysis of the set of replicate data points. In a further embodiment, individual data points are used to create a “triple,” or three value vector, using the data value, its first derivative, and its second derivative. Once the individual triples are created, an iterative process of creating replicate data points continues until a sufficient number of triples are available for statistical analysis. Once the requisite sample size is observed and/or replicated, the data is then analyzed.

Further, it should be understood that the computation of the first and second derivative may use “smoothed” data for computing the first and second derivative values. For example, in an embodiment of the syntactical system in which the raw data includes noise variances, the raw data of each of the plurality of data points may be smoothed by any manner within the scope of step 604. The smoothed raw data may then be combined with replicate points (or replicated) according to any manner within the scope of step 606 (disclosed above), whereby the first and second derivative of each data point is computed.

With reference to step 608 of FIG. 6, the system of the instant disclosure assigns each data point 306 of chromatogram 300 a grammar element. FIG. 7 depicts chromatogram 300 of FIG. 5, showing that a grammar element has been assigned to each of the plurality of data points 306.

As illustrated in FIG. 7, one of four grammar elements has been assigned to each data point of the plurality of data points 306. The four different grammar elements represented in FIG. 7 include: baseline <B>; rising edge <R>; peak <P>; and falling edge <F>.

According to an embodiment of the syntactical system and method, data points 306 in which the first and second derivates are determined to be statistically insignificant from zero are assigned a grammar element of <B>, representing a baseline. Data points 306 in which the first and second derivatives are both positive values (and having statistically significant positive differences from zero) are assigned an <R> grammar element, representing a rising edge. Data points having a first derivative statistically insignificant from zero and a positive second derivative are assigned a <P> grammar element, representing a peak. Data points having a negative first derivative and a positive second derivative are assigned an <F>, representing a falling edge grammar element. The particular letters associated with the grammar elements are immaterial to the present invention, and are assigned based on language and terminology preferences.

Further, according to embodiments of the disclosed syntactical system, statistical significance may be determined, for the purpose of assigning grammar elements, based on preset limits which relate to the difference of the first derivative from zero, and the difference of the second derivative from zero. In one such case, each data point 306 having first and second derivative values within the preset limits would be assigned a <B> grammar element indicating both the first and second derivative values are statistically insignificant from zero. Likewise, when both the first and second derivatives have values which are positive, and outside the preset limits, the data point 306 is assigned an <R> grammar element indicating that the first and second derivate values are both positive and statistically significant from zero.

In a typical chromatograph, noise is added to a signal. When such noise then modifies the derivatives of measured data points and derivatives estimated in filters, the filters provide the derivatives but these are affected by the noise. The disclosed bootstrapping captures the noise of a chromatogram and redistributes it. For example, by performing one hundred bootstraps at each selected time, one hundred different pieces of noise are placed onto the signal; thereby, the effect of the noise on the derivatives is determined in order to modify the assignment of grammar elements, because the grammar element type depends upon the derivatives. Accordingly, by simply bar graphing each selected point in time, the effect of the chromatographic noise on the assignment of the grammar may be seen. As shown in the example of FIG. 7, the peaks with a syntax labeled “P” and that have P grammar elements are substantially unaffected by the noise. The composition of these P bars in the illustrated vertical direction is nearly all P elements (dark shading). By comparison, for the example of FIG. 7, the first-in-time syntax labeled “B” includes a random collection of grammar assignments because the noise randomly changes these grammar assignments. It can be seen that the use of bootstrapping thereby significantly improves peak identification by grammar assignment. In other words, the original chromatogram does not provide useful information regarding how the noise on derivatives for a given point affects the assignment of a grammar type. Without bootstrapping, it would only be possible to assign a single grammar element to the point, and there would be no way to judge the accuracy of such assignment. For example, by bootstrapping the noise to create one hundred synthetic chromatograms, one hundred first and second derivatives may be computed at each point. These will be different depending upon how the computed values are modified by the changes in noise. These changes in derivative values then create, for each point, the distribution of grammar elements shown in FIG. 7. The identification of peaks may be based upon these distributions at each point.

Additionally, in some further embodiments of the disclosed system in which data points 306 are combined with corresponding data points of replicates (as discussed in step 606 of flowchart 600), statistical significance may be defined by the standard deviation values of the first and second derivatives of each of the data points 306.

Further, additional embodiments of the disclosure may also utilize a “predictive value” based on the type of assigned grammar element of each of the data points 306 positioned adjacent to each subject data point 306 along the x-axis 302. In general, peaks such as first peak 310 and second peak 310′ of chromatogram 300 follow similar grammar element orders (e.g., <B><B><B><R><R><R><P><P><P><F><F><F><B><B><B>). Therefore, a predictive value (representing the likelihood of what an adjacent grammar element will be) may be computed based on the grammar element adjacent to a data point 306. Thus, a data point which has an adjacent and prior data point assigned a <R> grammar element, and an adjacent and later data point assigned a <P> grammar element, will have a predictive value favoring one of the grammar elements <R> or <P> being assigned thereto based on probability. In another example, suppose there is a sequence of grammar <R><R><R><B><P><P><P><F><F><F>. The correct peak syntax does not occur because of the orphan <B>. By looking at the grammar distribution for that point, it is possible to determine if it can be reassigned as <R> or <P>. As a numeric example, if out of 100 bootstraps there are 40 <B>, 38 <R> and 22 <P>, a reasonable tactic would change <B> to <R> and yield the correct peak syntax. Whereas, if there are 90 <B>, 7 <R>, and 3 <P>, the apparent peak is most likely not real.

Referring next to step 610 of FIG. 6, a segment list is generated. According to an embodiment of the disclosed syntactical system, grammar segments are assigned to regions or areas of the data represented by chromatogram 300 (see, e.g., along the x-axis 304 of FIG. 7) which have a concentration of the same types of grammar element assigned to data points 306 therein. As illustrated in FIG. 7, adjacent data points are often assigned identical grammar elements, thus a single grammar segment can be assigned to represent several adjacent data points which have the same grammar element assigned thereto. According to the grammar segments depicted along the x-axis 302 of FIG. 7, each grammar segment comprises three indices: type (e.g., one of <B><R><P><F>); start (e.g., the x-axis position at which the segment begins); and length (e.g., the number of data points or x-axis positions the segment spans).

Further, although a grammar segment may be assigned to a region of a chromatogram 300 comprising all identical grammar elements (assigned to the data points 306 therein), it is possible and generally the case that grammar segments will contain some data points having non-identical grammar elements assigned thereto. For example, a region of a chromatogram 300 represented by a grammar segment comprising the indices type <R> may contain at least one data point 306 that is represented by a grammar element <B>. Furthermore, because grammar segments may contain data points having non-identical grammar elements assigned thereto, thresholds may be utilized in regard to the assignment of grammar segments to regions of a chromatogram 300 in which not all the adjacent grammar elements are identical types. For example, intense peaks typically show little noise (e.g., the two <P> segments shown in FIG. 7) and the grammar distribution is overwhelmingly one type. Whereas, in noisy areas (e.g., the first <B> of FIG. 7) each point has a wide distribution of grammar types. In both cases, it is the distribution of bar heights for each point in time that indicates the fraction out of 100 for each grammar type.

Remaining with FIG. 7, the regions in which grammar segments are assigned are not static within chromatogram 300, but are generally dynamic and vary based on the locations of the assigned grammar types. However, embodiments of the disclosed syntactical system may alternatively include designating pre-defined regions within the data represented by the chromatogram 300 (for grammar segment assigning purposes).

Upon assigning grammar segments to respective regions of chromatogram 300 having concentrations of the same grammar elements (assigned to adjacent data points 306), a segment list may be established. As used herein, a segment list comprises a vector representing the grammar segments of a data set, such as represented by chromatogram 300. The segment list is generally structured in an ordered manner based on the position (e.g., within the data set represented by chromatogram 300) each grammar segment is assigned. For example, one segment list within the scope of the disclose embodiment is ordered from the grammar segment which is “earliest in time” to the “latest in time.” Other arrangements are possible depending on the variable for which each segment is associated.

Moving to step 612 of FIG. 6, the segment list is analyzed for identifying the presence of valid peak syntaxes. According to the exemplary embodiment of the syntactical system shown in FIG. 7, valid peak syntaxes include: <R><P><F>; <R><P><R><P><F>; and <R><P><F><P><F>. Further, it is within the scope of the present disclosure to establish/define custom peak syntaxes to be identified within a segment list.

The peak syntax <R><P><F> represents what is considered a basic peak whereas the peak syntax <R><P><R><P><F> represents peaks having a “shoulder” on the rising edge. The peak syntax <R><P><F><P><F> represents peaks with a “shoulder” on the falling edge. A shoulder may be caused by, for example, two compounds in a sample having nearly identical retention times. For example, if one of the compounds, possibly a contaminant, has a lower concentration (or produces a weaker response with the data collection component 404) a shoulder along an edge of the peak may result.

The analysis of the segment list as described at step 612 also eliminates identification (or “calling”) of peaks which are not valid peaks, but which exhibit “peak-like” features formed by noise, background and other variances. For example, analysis of the segment list as disclosed by step 612 eliminates identification of regions of a chromatogram having a <B><R><B> region.

Referring next to step 614 of FIG. 6, a probability of assignment may be determined. The probability of assignment relates generally to the confidence level that an identified peak is truly a peak. The ability to determine the probability of assignment is another advantage of the syntactical system disclosed herein. Peak probability may be determined in the following way. Once a valid peak syntax of grammar segments is found, <R><P><F>, the <P> segment is examined. A grammar segment represents a contiguous set of identical grammar elements. Thus, a <P> segment ordinarily covers more than one point. For example, the second <P> in FIG. 7 is associated with six points.

According to one embodiment of the disclosed system, the probability of assignment is determined by examining the extent to which a <P> grammar segment is contaminated with <B> grammar types. As explained above, it is possible that a grammar segment may represent a region of a chromatogram 300 which contains some contaminating data points. By determining the percentage of <B> grammar types (representing contaminating data points) within a <P> grammar segment, a probability of assignment is determinable.

Peak probability may be estimated by a heuristic using the number of <B> “contaminations” for each point associated with the <P> segment. The average of this number may then be used in the following exemplary method; this heuristic eliminates almost all “accidental” peak syntaxes that are due entirely to noise. A method for calculating the probability of assignment according to the syntactical system disclosed herein is given by the following heuristic theorem: (a) average the number of <B> grammar elements (avgB) across the <P> grammar segment; (b) divide this value by 100 and subtract from 0.5; (c) multiply this value by 2; and (d) square the result. Expressed as an equation this theorem is represented by:

p=[2(0.5−avgB/100)]².

Although not depicted, it is within the scope of the disclosed syntactical system that a threshold regarding the probability of assignment may be assigned. For example, in order to identify a peak syntax as a valid data peak, the <P> grammar segment must have a probability of assignment value above the threshold percentage. In some cases a probability of assignment of greater than 80% is reasonable. Thus, assuming an 80% probability of assignment threshold, based on the heuristic theorem outlined above, a <P> grammar segment within one of the peak syntaxes (disclosed above) must also have a probability of assignment value above 80% before the peak syntax is identified as a data peak.

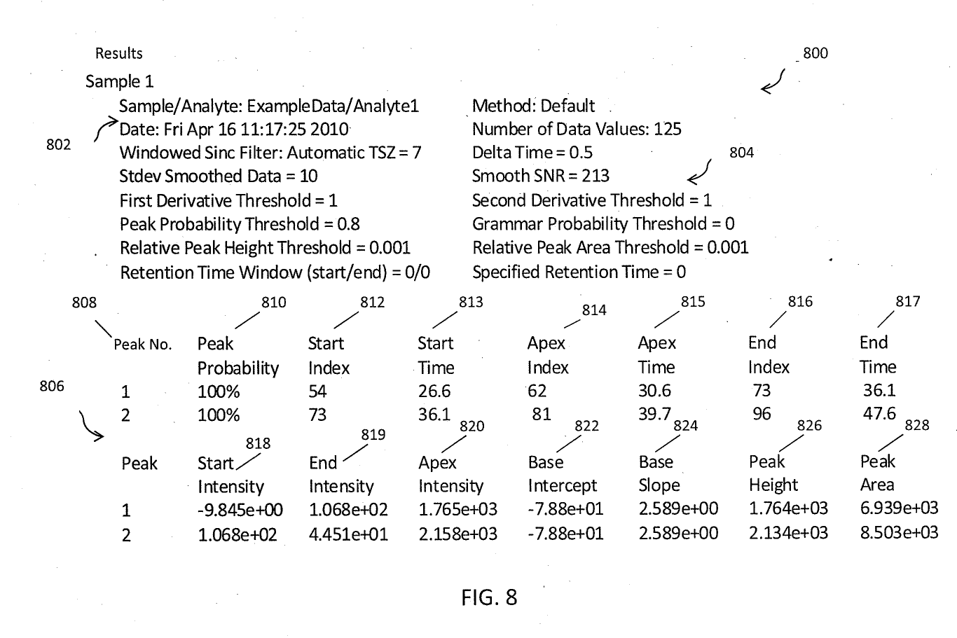

Referring next to step 616 of FIG. 6, once valid peak syntaxes are identified according the methods described herein, peak list 800 may be generated. FIG. 8 illustrates one embodiment of peak list 800 within the scope of the disclosed syntactical system. However, data (or information) included with peak list 800 may be specifically customized to meet individual desires or needs.

With reference to peak list 800 of FIG. 8, the data included therein includes: sample identification information 802; analysis parameter information 804; and data peak information 806. Sample identification information 802 includes a sample number, sample name, and the date and time during which the sample was analyzed by analytical instrumentation 400 (see, e.g., FIG. 4). Analysis parameter information 804 of the syntactical system includes various data content, including threshold values created for the analysis, smoothing filter information, and retention time values (discussed in further detail below).

Data peak information 806 of peak list 800 may be configured to include various data values derived from the process of identifying data peaks and/or the process of analyzing identified data peaks. By way of example, data peak information 806 may include data values derived from the process of identifying data peaks such as peak number 808 (corresponding to the individual peaks identified by the disclosed syntactical system), peak probability 810 (corresponding to the probability of assignment value as discussed above), start index 812, apex index 814, and end index 816, (corresponding to the individual data points in sequential order at which the identified peak syntax begins, the apex is located, and the peak syntax ends, respectively), and start time 813, apex time 815, and end time 817 (corresponding to the x-axis position at which the identified peak syntax begins, the apex is located, and the identified peak syntax ends, respectively).

Additionally, FIG. 8 illustrates data peak information 806 as also including data values representing computations performed on the identified data peaks such as intensity values (illustrated as start 818, end 819, and apex 820 intensity), base intercept 822, base slope 824, peak height 826, and peak area 828. Peak height 826, for example, represents the amplitude at the peak apex minus the baseline amplitude. Peak area 828 indicates an area defined underneath a data peak and may be computed using Simpson's extended formula of order 1/L³:

$$A = \frac{Δ t}{12} ( 5 {y}_{1} + 13 {y}_{2} + 12 {\sum }_{i = 3}^{L - 2} {y}_{i} + 13 {y}_{L - 1} + 5 {y}_{L} )$$

(where the parameter Δt is given by Δt=(t_{L}−t₁)/(L−1)). In one embodiment, if less than five data points describe the peak, a sum of areas (e.g., A=Δt(y₁+y₂+y₃+y₄) where Δt=(t₄−t₁)/(L−1)) may be used in calculating the peak area.

Other data peak information 806 depicted in FIG. 8 includes base intercept 822 and base slope 824. The base slope 824 and base intercept 822 define the line used as the base (or bottom) of the data peaks. By way of example, the y-axis 304 variable for each data point 306 in a peak may be given by the y-axis 304 variable (for a data point 306) minus the bottom of the data peak (as defined by the base slope 824 and base intercept 822). As such, the peak area 828 may be computed with the y-axis 304 variable for the data point 306 minus the bottom of the data peak as defined by the base slope 824 and base intercept 822.

For example, and with specific reference to FIG. 8, base slope 824 and base intercept 822, respectively, are defined according to the following equations:

$$slope = \frac{{y}_{end 2} - {y}_{start 1}}{{t}_{end 2} - {t}_{start 1}} = \frac{44.51 - ( - 9.85 )}{47.6 - 26.6} = 2.588$$

$$and$$

$$intercept = {y}_{start 1} - slope \times {time}_{start 1} = - 9.845 - 2.588 \times 26.6 = - 78.7$$

(where y_{end2} is the end intensity 819 for peak no. 2; yₛₜₐᵣₜ₁ is the start intensity 818 for peak no. 1; t_{end2} is the end time 817 for peak no. 2; tₛₜₐᵣₜ₁ is the start time 813 for peak no. 1; and slope is base slope 824).

In a further exemplary embodiment of the disclosed system and method, the data points or ranges of the x- and/or y-axes may be selected for analysis. For example, in one embodiment of the instant disclosure a retention time (or other x-axis range) may be selected for identification and analysis of data peaks specifically within that time period. If, for example, a retention time is selected, the data points within the selected retention time may be “fit” (or adjusted for analysis according to the methods described herein) using an exponentially-modified Gaussian (EMG) function. An exemplary EMG formula includes:

$$EMG ( t ) = \frac{A σ \sqrt{π / 2}}{τ} exp ( \frac{{σ}^{2}}{2 {τ}^{2}} - \frac{( t - μ )}{τ} ) erfc ( \frac{σ}{τ \sqrt{2}} - \frac{( t - μ )}{σ \sqrt{2}} )$$

in which A is the peak amplitude, μ is the peak location, σ is the peak spread, and k is a shape parameter (the exponential decay constant). This equation is solved by using a standard non-linear least squares analysis using initial guesses for μ, σ, and τ based on parameters given in the peak list.

A “fitting” procedure, as described herein, has the ability to perform weighted fitting of the retained (or selected) data points and peaks. One method of weighted fitting utilizes a bootstrap distribution of grammar types (e.g., FIG. 7 and related discussion) to compute the least-squares weights. Weighted fitting, within the scope of the present disclosure, may also utilize probabilities of assignment values derived from the grammar type distributions of adjacent <R> and <P> grammar segments and adjacent <P> and <F> grammar segments (identified within a valid peak syntax). For example, the weighted values of the retained data points may be determined using a two-step process:
a) First, data points in an <R> grammar segment (adjacent to a <P> grammar segment and within an identified peak syntax) are assigned the counts associated with the grammar types assigned to the individual data points within that <R> grammar segment. Thus, the counts of the grammar types within the <R> grammar segment include the weighted value for the <R> grammar segment.
b) For data points within the adjacent <P> grammar segment, the weight value includes the counts associated with data points therein having the grammar type <P> assigned thereto.
c) For the data points in the <F> grammar segment (adjacent to the <P> segment within the identified peak syntax), the weight value includes the counts associated with the <F> grammar types (within that <F> grammar segment).
   For example, within the <R> segment each point is weighted by the number of <R> grammar types, within the <P> segment by the number of <P> grammar types, within the <F> segment by the number of <F> grammar types, etc. For the second peak in FIG. 7, all points except the rightmost <P> would be weighted 100. The rightmost <P> is weighted at approximately 95. For the first peak, the initial <P> is weighted less than 100, and the first and last two <F> are weighted less than 100.

According to an embodiment of a fitting method within the scope of the present disclosure, all weight values have values from 0 to 100 (the number of replicates) depending upon the presence of contaminating data points (described in detail above) within the grammar segment.

When using an EMG function, as described herein, peak height and peak area may be determined for the fitted (selected or retained) data points. Peak height, for example, is determinable by numerically locating the function maximum. Note that in determining peak height, A is not used since it is the amplitude of the underlying Gaussian and not the skewed peak. As explained above, initial guesses for μ, σ, and τ are determined based on parameters given in the peak list. Once these estimates are obtained, the EMG equations (above) may be used to determine the function maximum. Further, peak area, when using an EMG function as described herein, is determined by numeric integration of the function. One advantage of using the EMG function disclosed herein, for peak height and area, is the additional signal-to-noise enhancement provided by the least squares procedure.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A method of determining the presence of at least one data peak within a plurality of data points, each data point representative of at least two empirical data variables relating to a sample, the method including the steps of:
determining at least one of a first and a second derivative for ones of a plurality of the data points;
assigning one of a plurality of grammar elements to correspond to ones of the plurality of the data points, said step of assigning comprising a comparison of the at least one of the first and second derivative to a reference value; and
compiling a grammar listing in which a grouping of grammar elements representative of a peak syntax may be identified therein for indicating the presence of at least one data peak, said steps of determining, assigning, and compiling being performed by executing a computer readable program with a processor of a computing device.

2. The method of claim 1, wherein the plurality of grammar elements comprises at least one of a baseline grammar element, a rising edge grammar element, an apex grammar element, and a falling edge grammar element.

3. The method of claim 2, wherein the grammar element assigned to each data point is indicative of a ratio of a slope value of the data point to a value representing a baseline.

4. The method of claim 3, wherein the slope value is derived from at least one of a first and a second derivative value of the data point.

5. The method of claim 4, wherein the first derivative (f1) value is obtained by convolution with a filter:
$$deriv {1}_{i} = {\sum }_{j = - M}^{M} f 1 ( j ) {data}_{i + j}$$
$$where$$
$$f 1 ( j ) = - \frac{1}{π {f}_{e} {j}^{2}} exp ( - π {f}_{r}^{2} {j}^{2} ) [ π {f}_{e} j cos ( π {f}_{e} j ) - sin ( π {f}_{e} j ) - 2 π {f}_{r}^{2} {j}^{2} sin ( π {f}_{e} j ) ]$$
f1(0)=0, and j runs over the interval from −M . . . 0 . . . M in unit steps.

6. The method of claim 4, wherein the second derivative (f2) the second derivative is obtained by convolution with a filter:
$$deriv {2}_{i} = {\sum }_{j = - M}^{M} f 2 ( j ) {data}_{i + j}$$
$$where$$
$$f 2 ( j ) = exp ( - π {f}_{r}^{2} {j}^{2} ) [ a \frac{sin ( π {f}_{e} j )}{π {f}_{e} j} + b cos ( π {f}_{e} j ) ]$$
$$a = {π}^{2} {f}_{r}^{4} {j}^{2} + 2 π {f}_{r}^{2} + 2 / {j}^{2} - {π}^{2} {f}_{e}^{2}$$
$$b = - 2 / {j}^{2} - 4 π {f}_{r}^{2}$$
$$and f 2 ( 0 ) = - {π}^{2} {f}_{e}^{2} / 3 - 2 π {f}_{r}^{2}$$
and where j runs over the interval from −M . . . 0 . . . M in unit steps.

7. The method of claim 4, wherein the slope value is derived from at least one of a first and a second derivative value of the data point and a smoothing process of the data point.

8. The method of claim 7, wherein the smoothing process includes convolving the data with a smoothing filter:
$${smooth}_{i} = {\sum }_{j = - M}^{M} f 0 ( j ) {data}_{i + j}$$
$$where$$
$$f 0 ( j ) = \frac{sin ( π {f}_{e} j )}{π {f}_{e} j} exp ( - π {f}_{r}^{2} {j}^{2} ) ,$$
i is the index of the data value being smoothed, the length of the filter is given by 2M+1 where M is a positive whole number, and f0(0)=1.

9. The method of claim 1, wherein the peak syntax comprises one of a normal syntax, a rising shoulder syntax, and a falling shoulder syntax, the normal syntax being indicative of the presence of the grammar element arrangement: rising edge, apex, falling edge; the rising shoulder syntax being indicative of the presence of the grammar element arrangement: rising edge, apex, rising edge, apex, falling edge; and the falling shoulder syntax being indicative of the presence of the grammar element arrangement: rising edge, apex, falling edge, apex, falling edge.

10. The method of claim 1, further comprising the step of assigning a probability of assignment value to each of the grammar elements assigned to each of the data points.

11. The method of claim 10, wherein said step of identifying a grouping of grammar elements further comprises analyzing the probability of assignment value associated with each grammar element.

12. The method of claim 1, wherein said step of indicating includes providing a peak list comprising a peak start location, a peak end location, and a peak apex location for at least one data peak indicated in said step of indicating.

13. The method of claim 1, wherein the step of indicating comprises indicating the presence of a peak syntax by presenting a data peak on a chromatogram.

14. The method of claim 1, further comprising the step of assigning one of a plurality of grammar segments to a plurality of data points that are in close proximity to one another and that have a concentration of like grammar element types, whereby the grammar listing comprises a plurality of the assigned grammar segments.

15. The method of claim 1, wherein the plurality of data points includes replicate data points of the sample.

16. The method of claim 15, wherein the replicate data points of the sample are derived by using the processor of the computing device to execute the computer readable program, the program being configured to receive the empirical data of the sample and derive replicate data points therefrom.

17. The method of claim 1, further including the step of displaying to the user a chromatogram comprising a plurality of the data points.

18. The method of claim 1, wherein the reference value for comparing the at least one of the first and second derivatives in said step of assigning is a value representing a zero baseline.

19. The method of claim 1, further comprising the step of generating the plurality of data points, each data point being representative of at least two empirical data variables relating to the sample, the step of generating being performed by analytical instrumentation.

20. A system for identifying a data peak, the system comprising:
a computing device having a processor and an associated memory; and
a peak identification software module stored in said memory and having a plurality of machine readable instructions enabling said processor to receive empirical data comprising a plurality of data points relating to a sample, each data point being representative of at least two empirical data variables relating to the sample, the software module further enabling said processor to assign one of a plurality of grammar elements to each of the plurality of data points, compile a grammar listing, identify a grouping of grammar elements representative of a peak syntax within the grammar listing, and indicate the presence of a peak syntax.

21. The system of claim 20, wherein the plurality of grammar elements comprises a baseline grammar element, a rising edge grammar element, an apex grammar element, and a falling edge grammar element.

22. The system of claim 20, wherein the grammar element is derived from at least one of a first and a second derivative value of the data point, the first and second derivative values of the data point being indicative of a ratio of a slope of the data point to a value representing a zero baseline.

23. The system of claim 22, wherein the grammar element assigned to each data point is further derived from a smoothing process of the data point.

24. The system of claim 20, wherein the plurality of peak syntax comprises a normal syntax, a rising shoulder syntax, and a falling shoulder syntax, the normal syntax being indicative of the presence of the grammar element arrangement: rising edge, apex, falling edge; the rising shoulder syntax being indicative of the presence of the grammar element arrangement: rising edge, apex, rising edge, apex, falling edge; and the falling shoulder syntax being indicative of the presence of the grammar element arrangement: rising edge, apex, falling edge, apex, falling edge.

25. The system of claim 20, wherein the software is further adapted to associate a probability assignment value with each of the grammar elements assigned to each of the data points.

26. The system of claim 20, wherein the software is further adapted to indicate the presence of one or more of a plurality of peak syntax by analyzing the grammar types assigned to the plurality of data points and the probability of assignment value associated with each grammar element.

27. The system of claim 20, wherein the software module indicates the presence of a peak syntax by presenting a data peak on a chromatogram.

28. The system of claim 20, wherein the grammar listing comprises a plurality of grammar segments representative of a plurality of data points in close proximity to one another and having a concentration of a same grammar element type.

29. The system of claim 20, wherein the computing device is integral with analytical instrumentation adapted to generate the plurality of data points.
